(19) United States
(12) Patent Application Publication
(10) Pub. No.: US 2009/0085413 A1
(43) Pub. Date: Apr. 2, 2009

(54) Magnetized Foucault Pendulum Energy Source, Earthquake Detection Device, Object Rotational Change Detection Device Using the Work of Jean Bernard Leon Foucault in 1851, The National Academy of Sciences Foucault Pendulum, Pantheon Pendulum and Museum of Science and Industry Foucault Pendulum

(76) Inventor: James Timothy Struck, Chicago, IL (US)

Correspondence Address: JAMES T. STRUCK OR;DINOSAURS, TREES, RELIGION AND GALAXIES, 2000 W. MORSE AVE., APT. 206, CHICAGO, IL, 60645, US

(21) Appl. No.: 11/865,730

(22) Filed: Oct. 2, 2007

(51) Int. Cl. H02K 33/00

(52) U.S. Cl. 310/37; 74/DIG. 9

(57) ABSTRACT

A magnet attached to a Foucault pendulum would cause a current in a coil. This could be used as a source of energy to provide power. This device could study the rate of oscillation change between a coil and a magnet on a Foucault pendulum. Magnet and Foucault pendulum interaction with coil gains understanding of electrical and magnetic interaction; there would be some frictional effect of coil, magnet and Foucault Pendulum. This device could use Astronomical Particle Power, Volcanic Power, Fish Power through the Falling of Astronomical particles, movement of a fish, heat from volcano tied to a pendulum to power a Foucault pendulum. Other sources of energy like hands, wind, burning of fuels, solar power, animal power, batteries, nuclear, chemical, physical energy or hydropower could be used as well. The device could detect earthquakes through Changes in Energy Produced in a Coil With A Magnetized Foucault Pendulum. The device could also detect Changes in Asteroid, Moon, Planet, Astronomical Craft Rotational and Spin Changes through changes in energy produced in a coil around a Magnetized Foucault Pendulum.

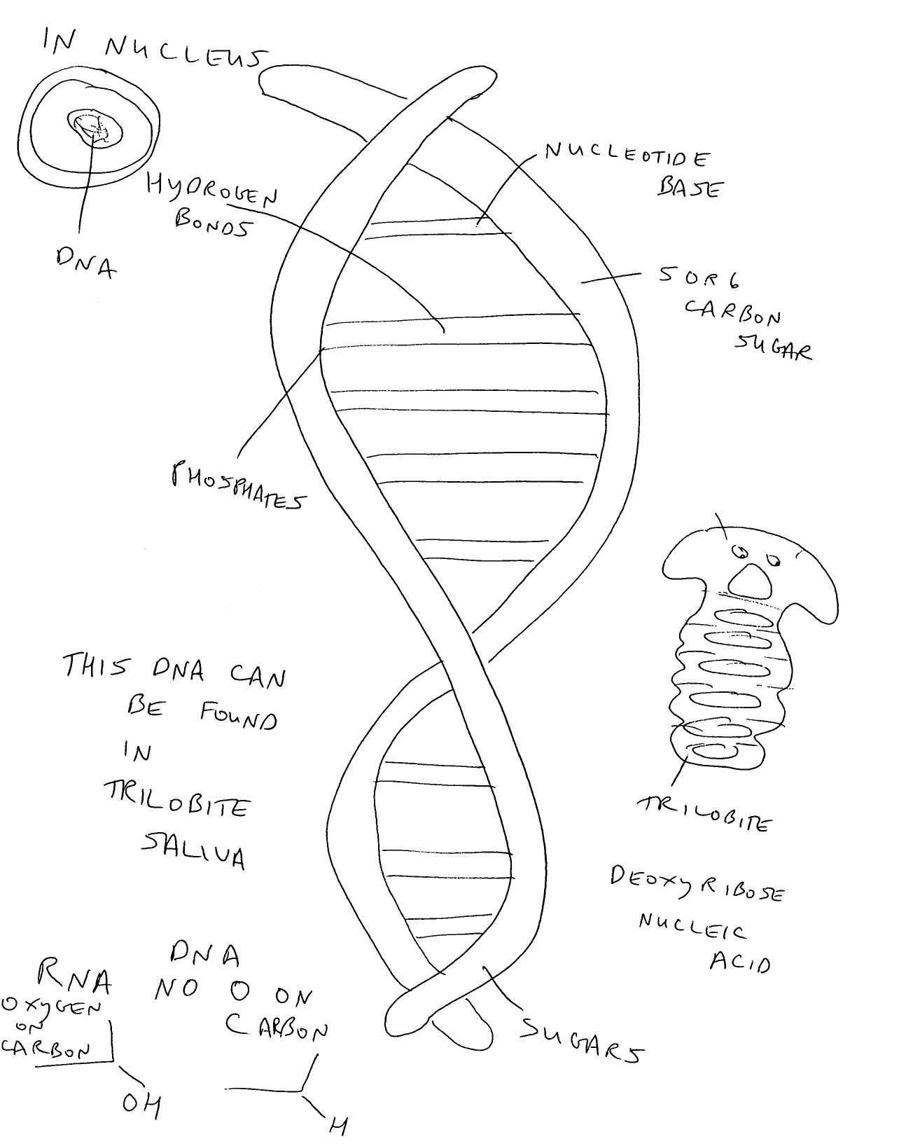

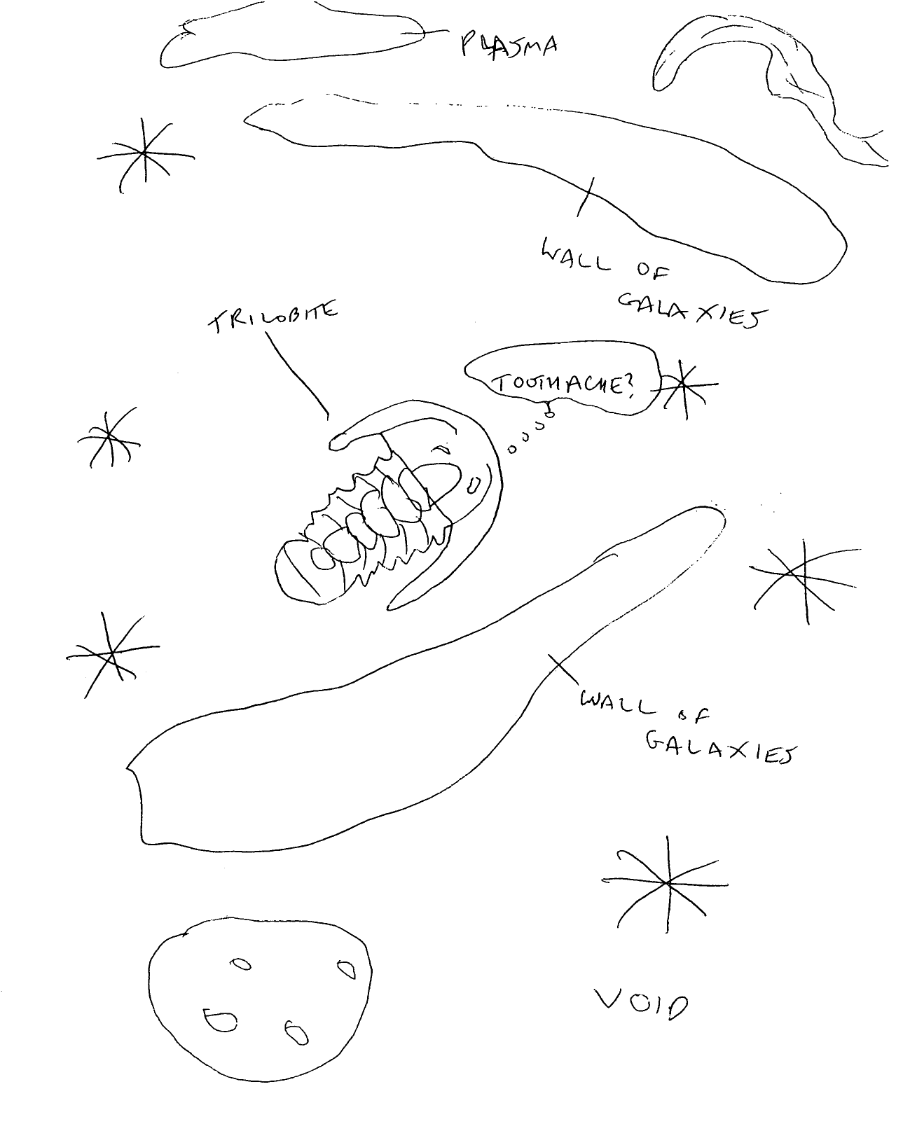

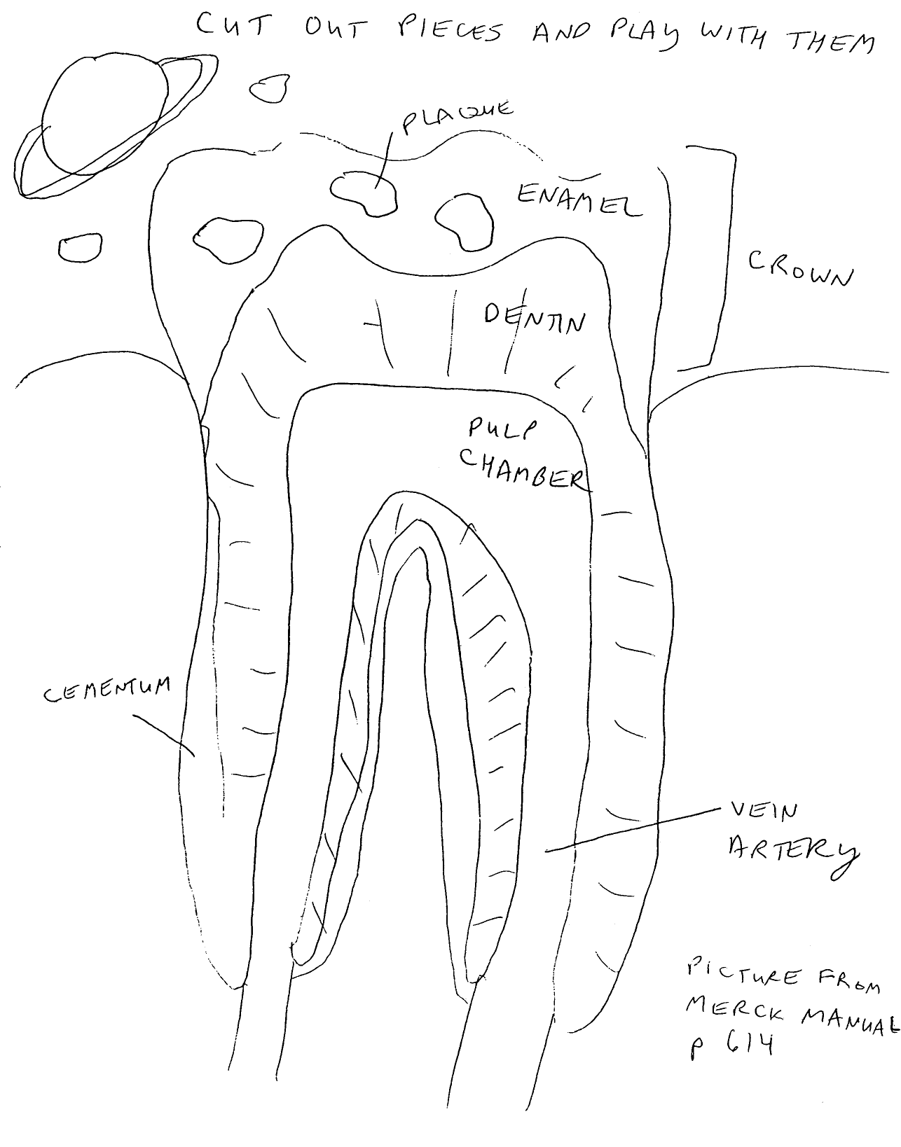

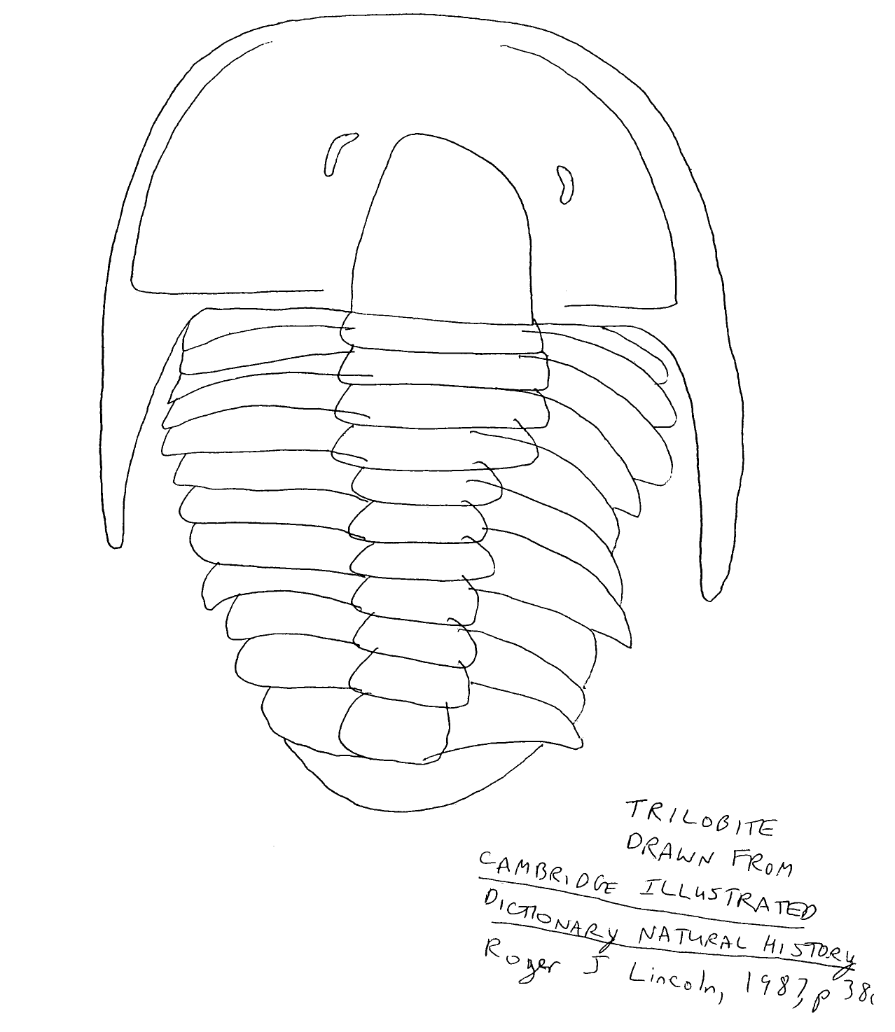

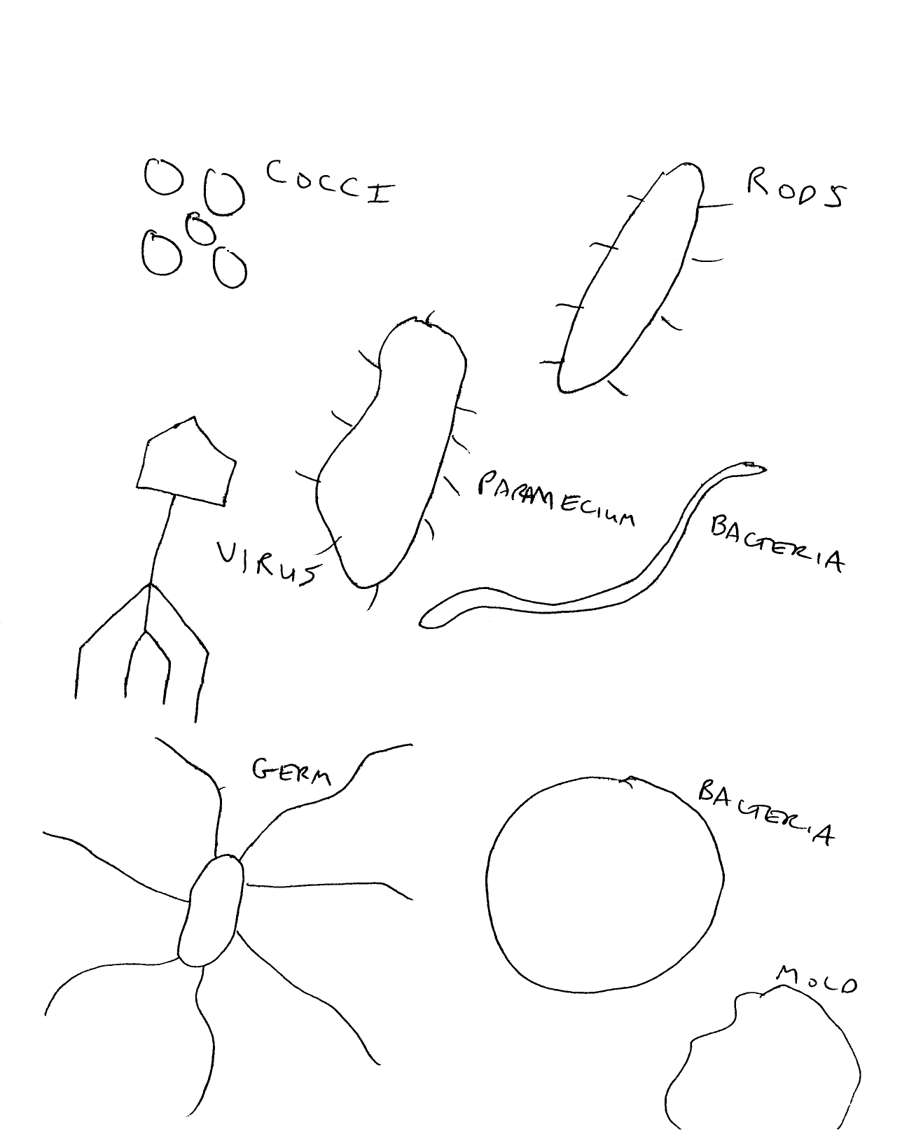

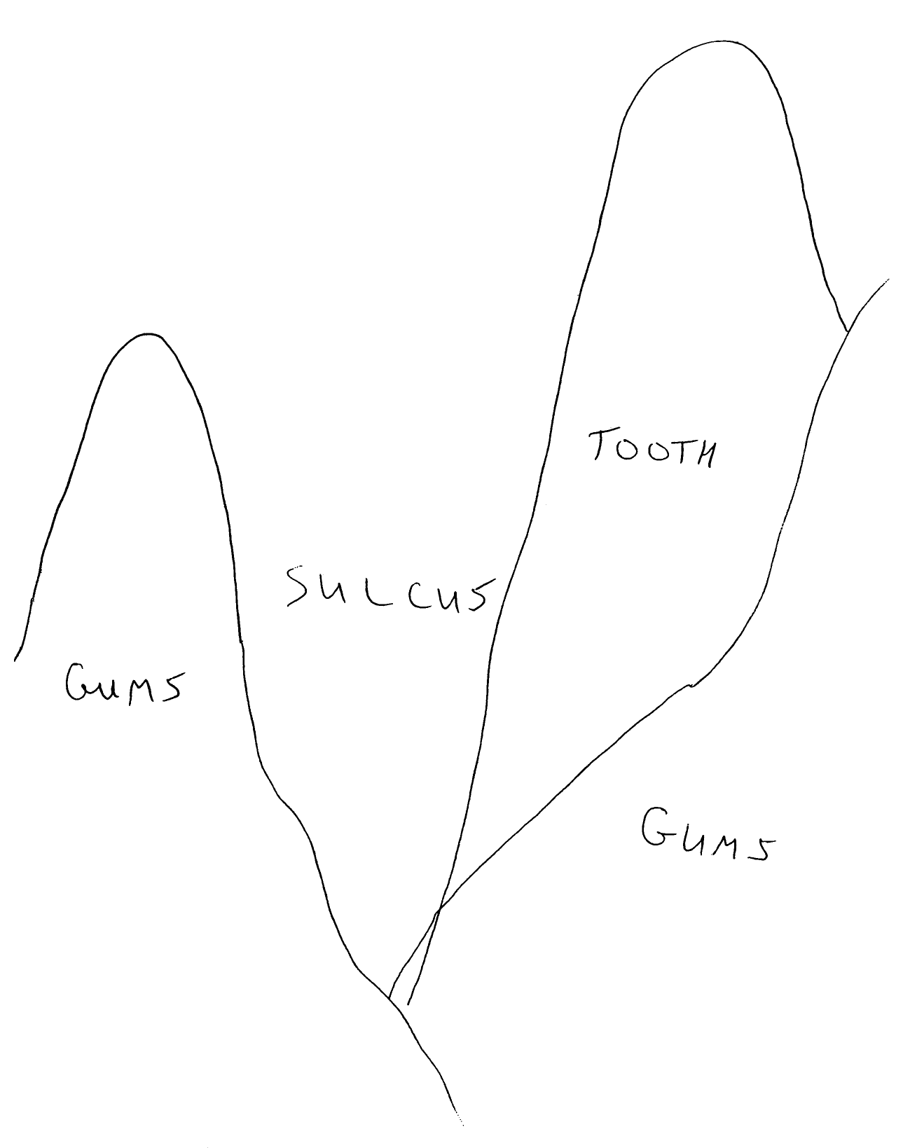

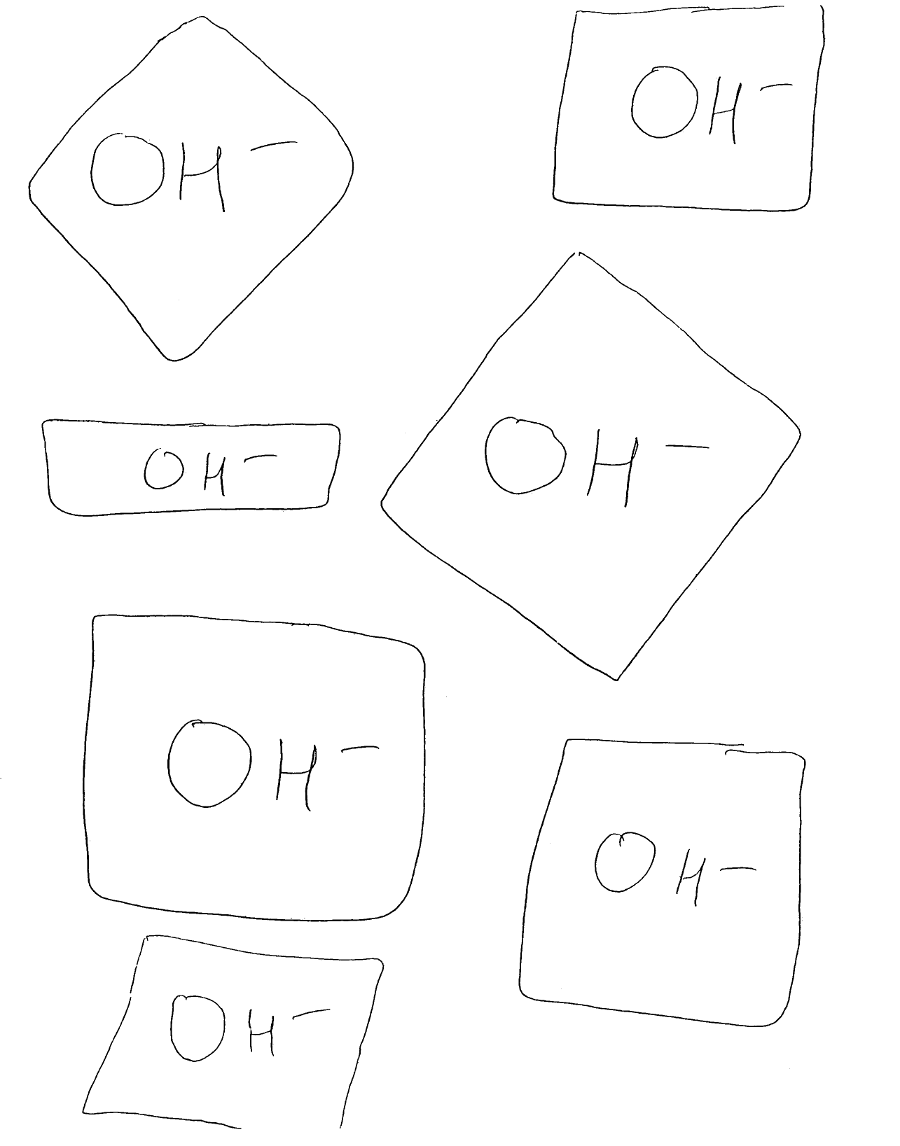

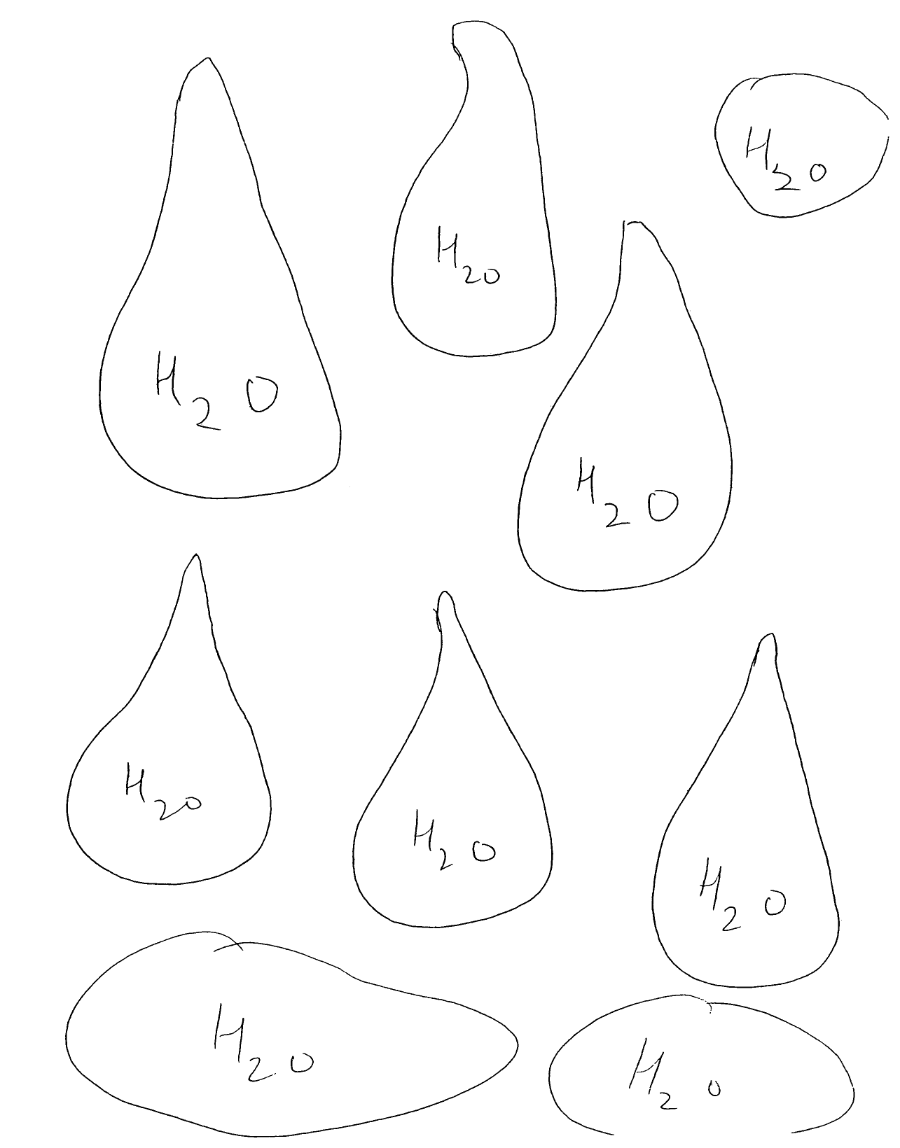

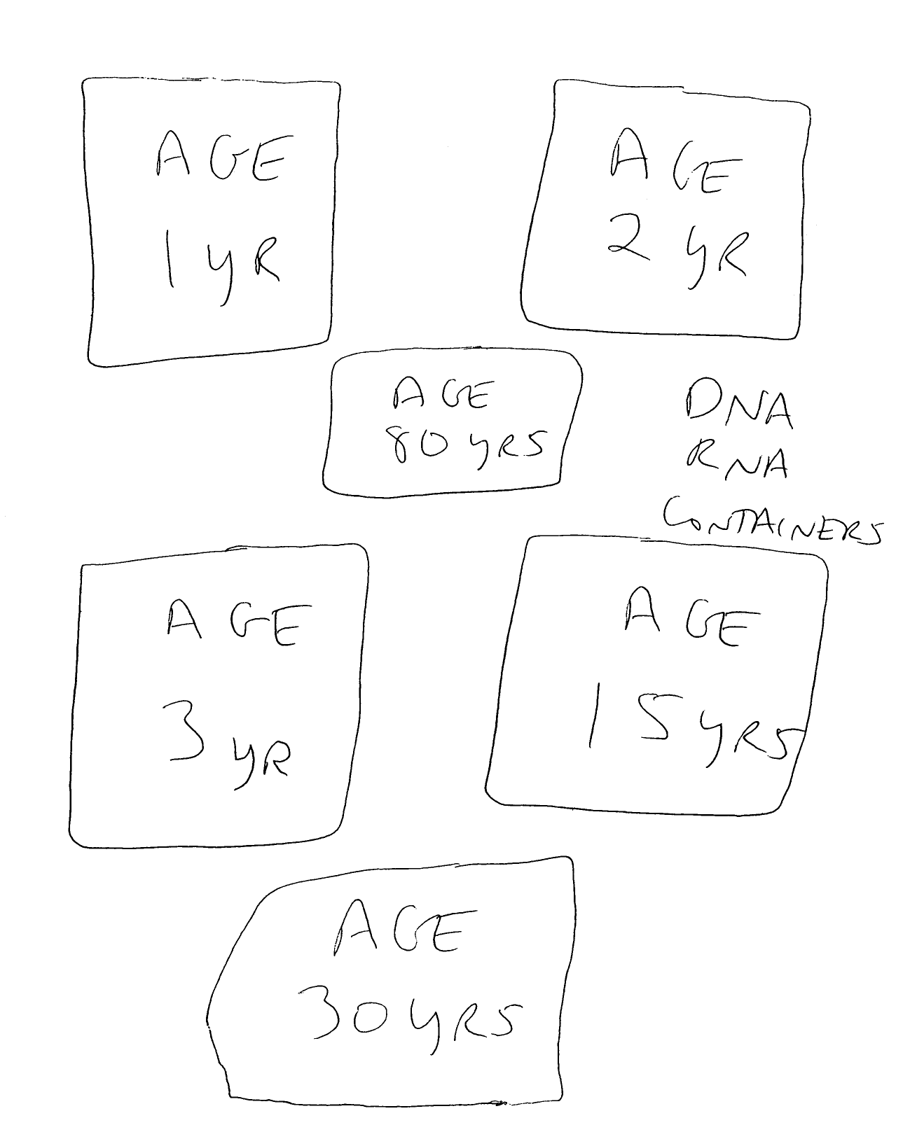

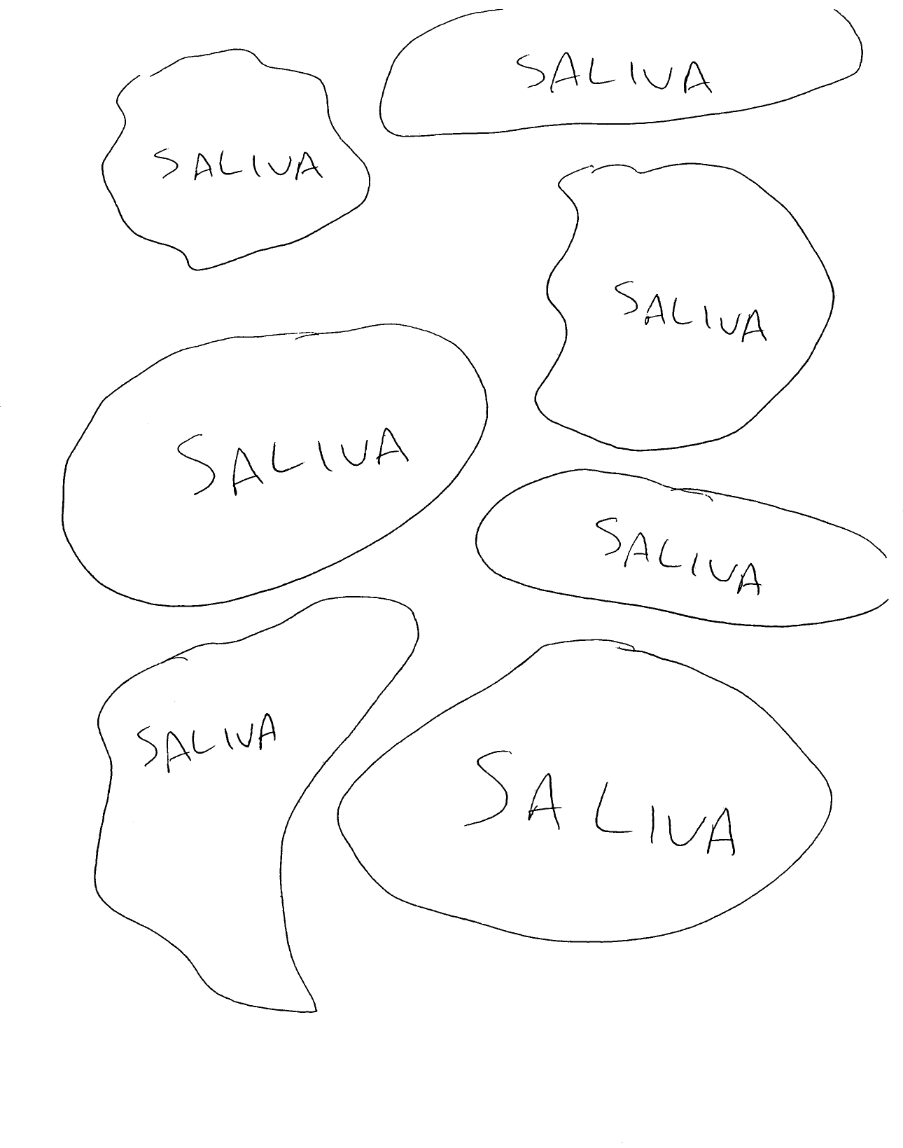

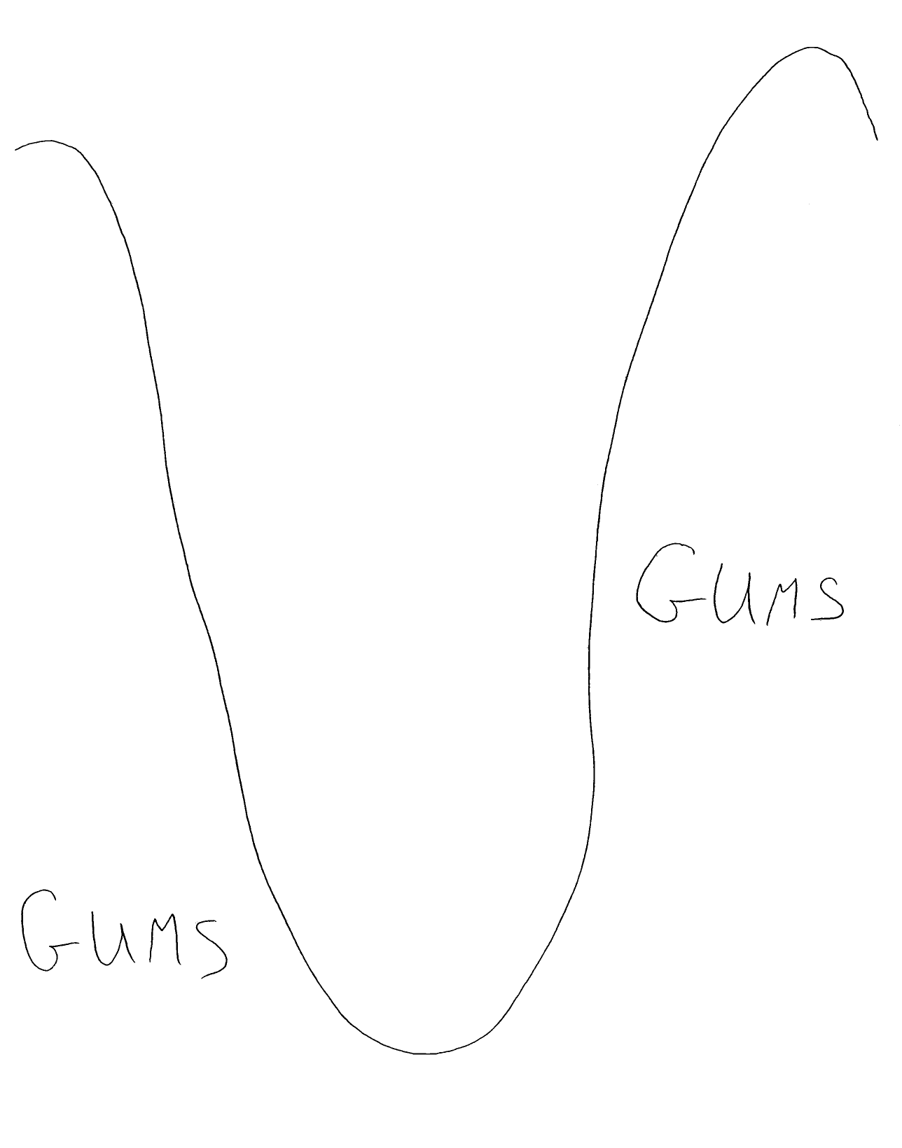

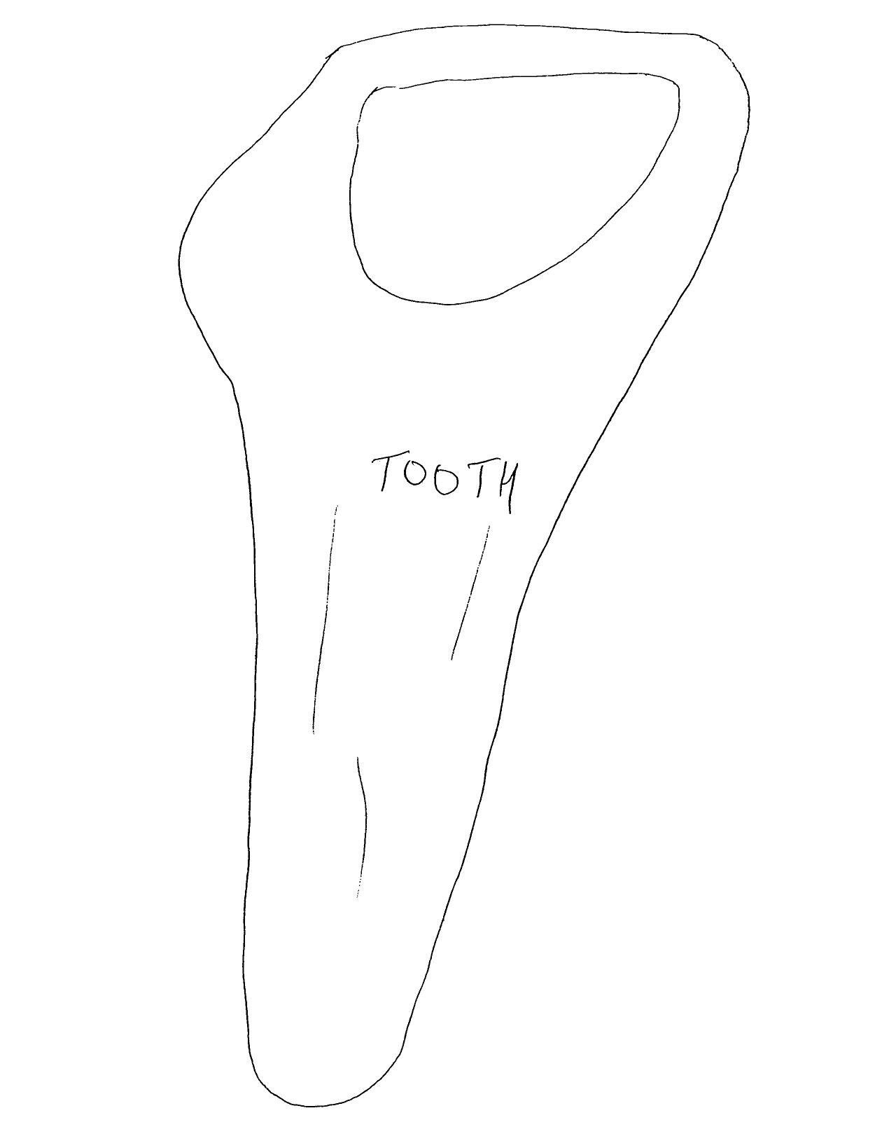

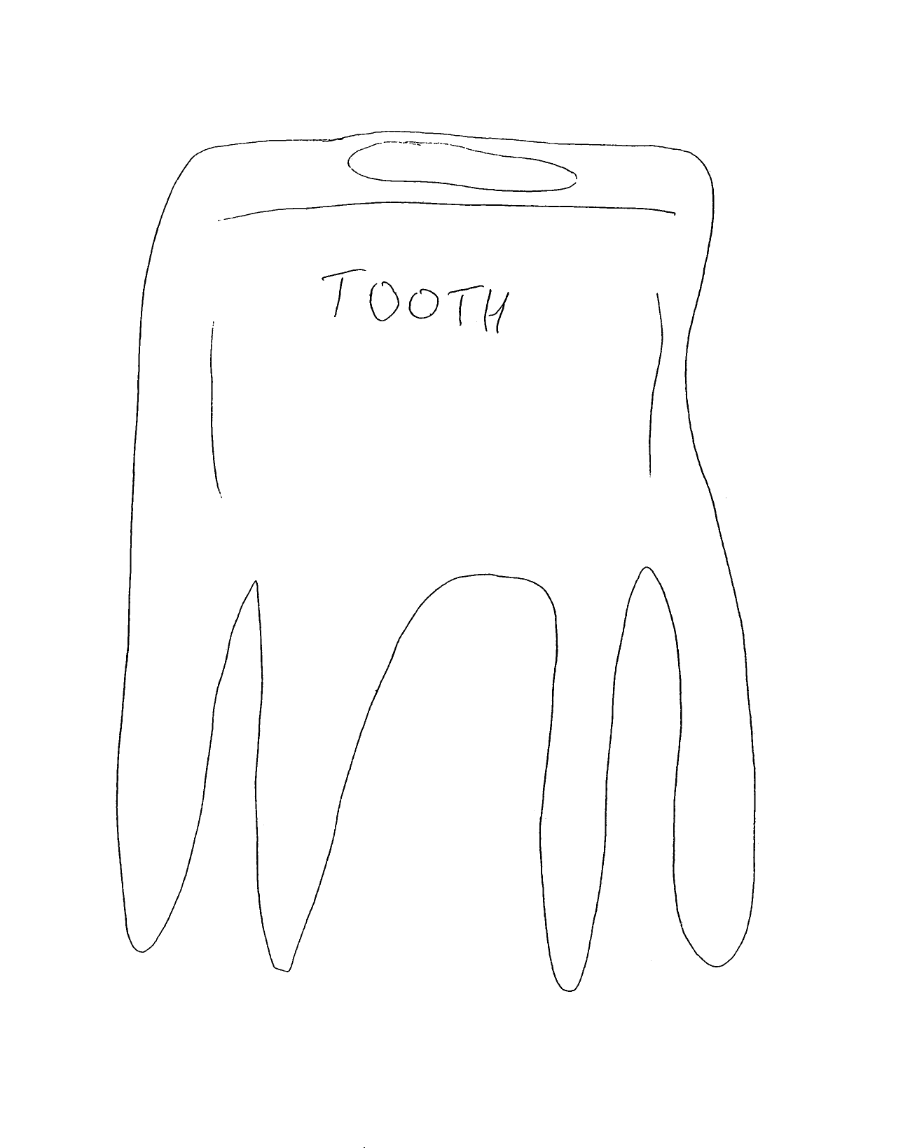

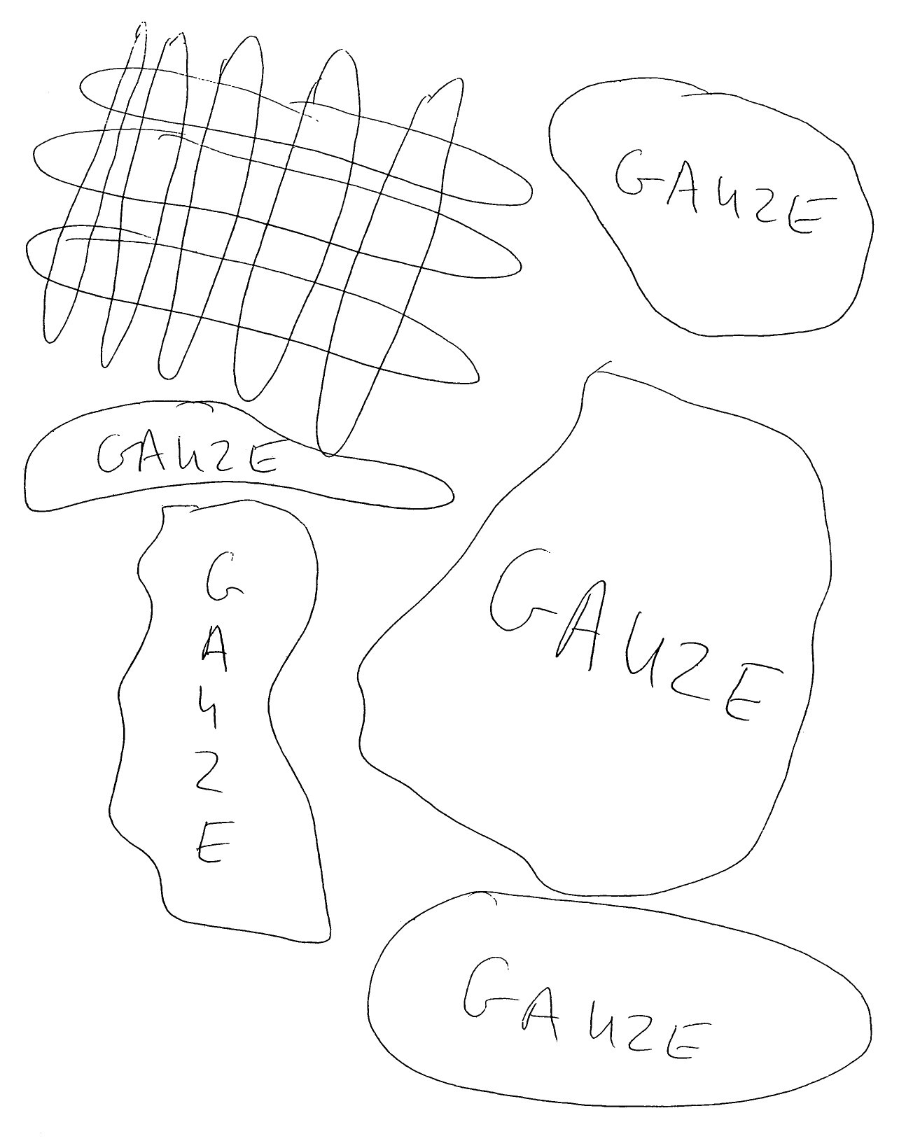

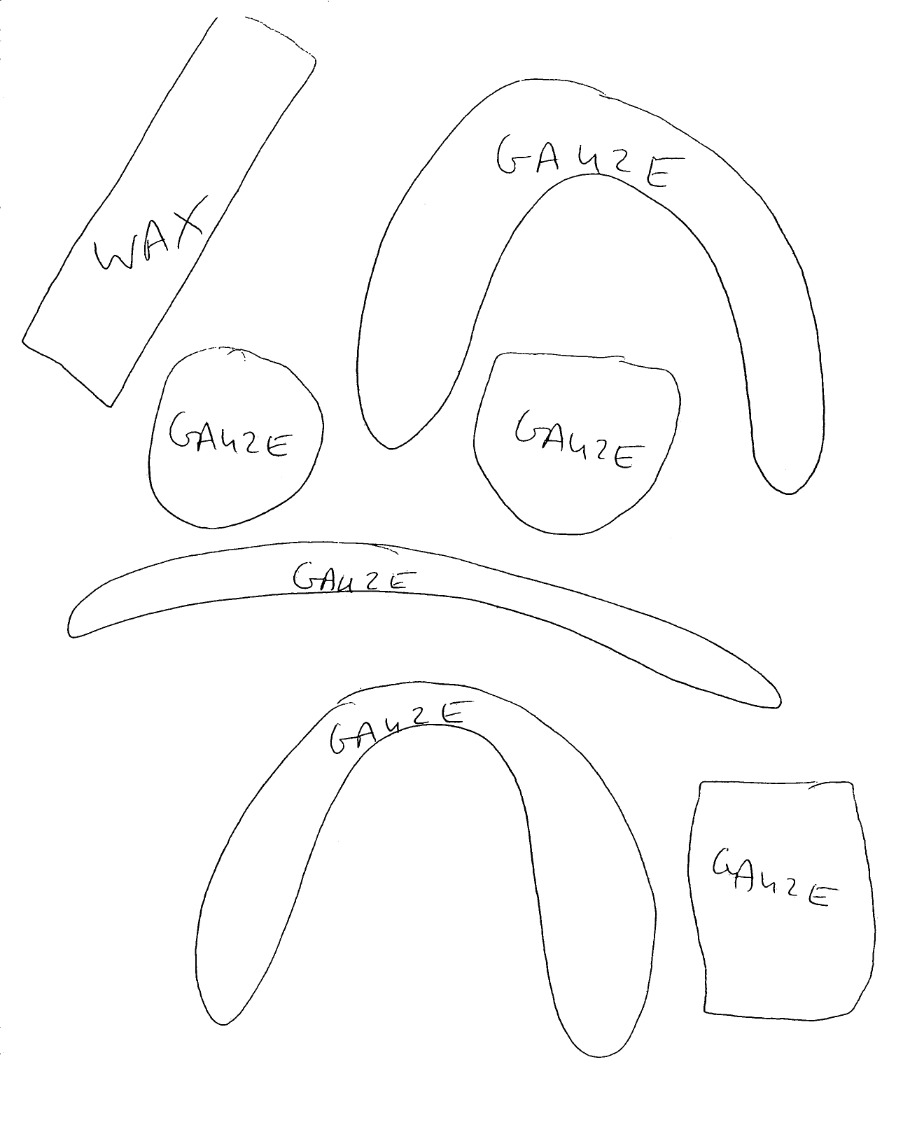

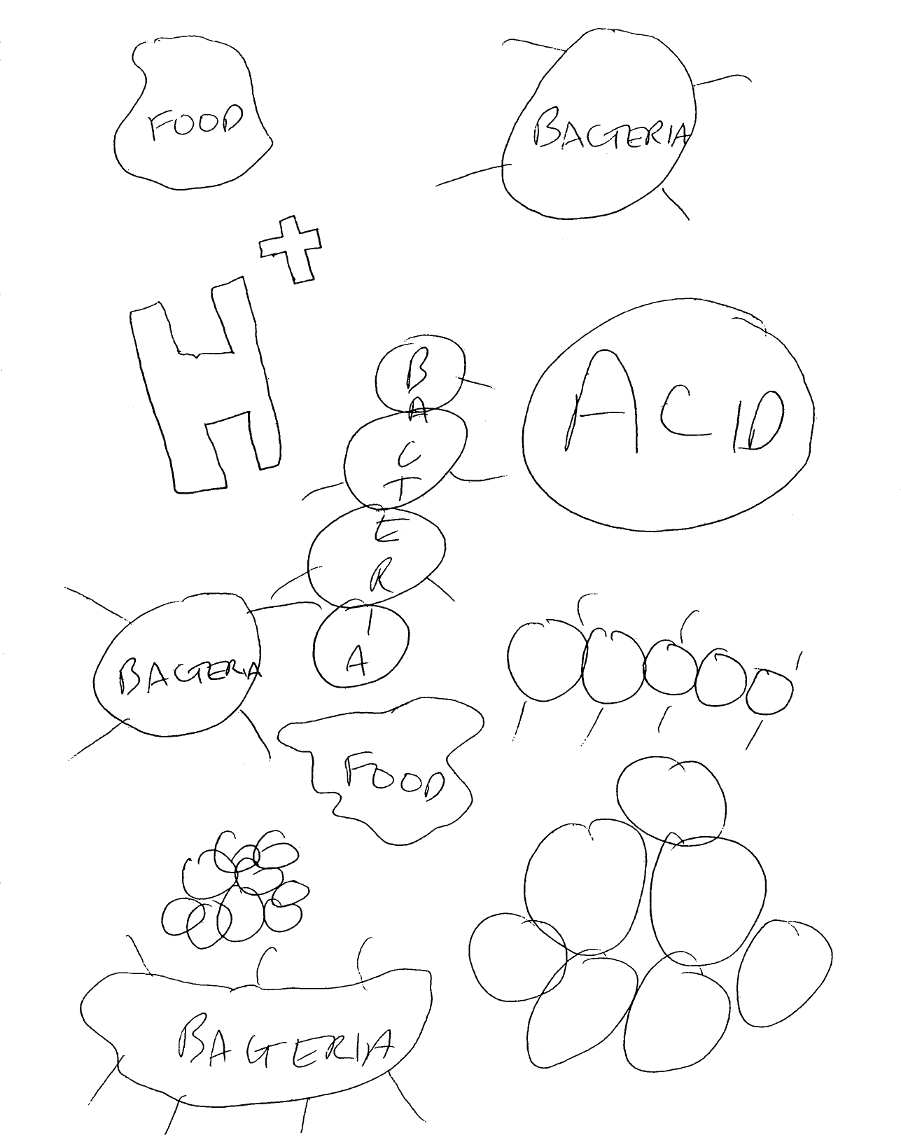

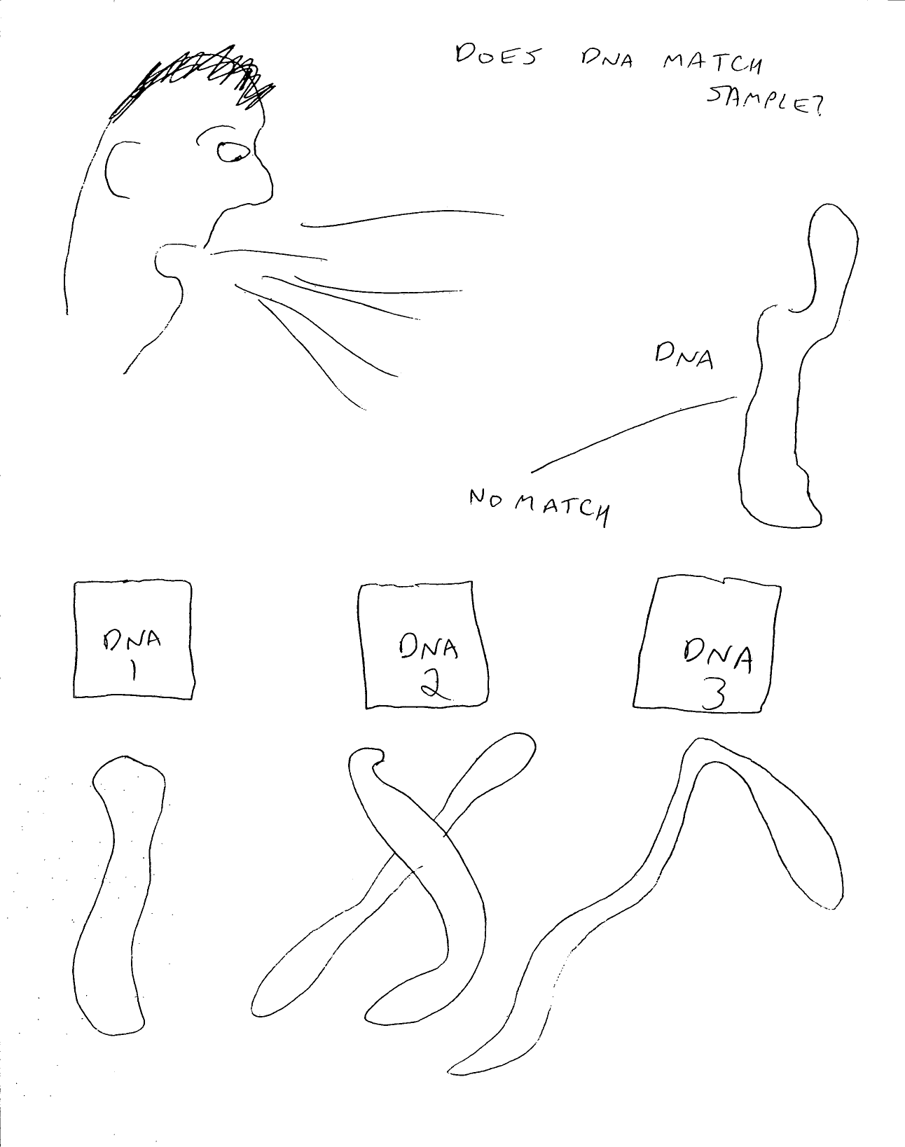

This patent application is derived from a USPTO document deposit filed in November 2005 on Thanksgiving weekend and received by the USPTO on Dec. 1, 2005. It is also related to a provisional patent application filed on Oct. 3, 2006. The Disclosure Document number is 590893. Below is some of the text of the disclosure document and provisional application.

The idea or text was sent to organizations like the National Academy of Sciences, The Museum of Science and Industry, and mentioned to the US Department of Energy, USGS, NASA, National Science Foundation and some other organizations like ComEd and some universities.

The only role played by the Museum of Science and Industry, Pantheon and National Academy of Sciences is that I observed the Foucault Pendulum in motion at both facilities; National Academy of Sciences in Summer 2001, Pantheon in 2003 and the Museum of Science and Industry vaguely as a child and more recently in September 2006.

Foucault's pendulum can be viewed in the Pantheon in Paris and National Academy of Sciences in Washington, D.C. and Museum of Science and Industry Chicago. The rotation of the pendulum is said to rotate in relation to the Earth's rotation. “The rotation of the plane of the swing of Foucault's pendulum was the first laboratory demonstration of the Earth's spin on its axis.” “The rate of rotation of a Foucault Pendulum at any given point is, in fact, numerically equal to the component of the Earth's rate of rotation perpendicular to the Earth's surface at that point.” (Encyclopedia Brittanica, p. 901 “Foucault Pendulum” Entry)

Foucault showed that the earth's rotation made the pendulum move, rotate, oscillate.

I combine this with ideas from electricity and magnetism. I hypothesized that combining the pendulum with a magnet could cause a current in a coil. On Nov. 26, 2005, I saw a children's book Straightfoward Science Electricity by Peter Riley at the Rogers Park Public Library Branch in Chicago. [Franklin Watts, Grolier, Danbury, Conn., 1998]

Page 20 shows

Dynamo Wheel

Magnet

[A Dynamo is pictured or drawn]

Coil

Coil Going Elsewhere

This contributed to the development of this document deposit. A magnetized Foucault pendulum would cause a current in a coil. There are possibilities the swinging pendulum's rate of oscillation is altered in interaction with the coil. The energy produced needs careful analysis. The energy will vary based on specific designs of the pendulum energy source. The pendulum energy source could be miniaturized or made small easily

Possibly made this small

[Four small Pendulums and coils of varying size are pictured]

Next Page Drawing Page 1/3 from Document Deposit

Foucault Pendulum Drawing

Magnet Attached to Foucault Pendulum

Electric Coil Underneath

Produces Current

Send Current Elsewhere

Page 2 of 3 of Drawings from Document Deposit

Magnet attached to Foucault Pendulum

[Different Sized Magnets or different structure or topology, surfaces, of magnets]

Page 3 of 3 of Drawings from USPTO Document Deposit

[Different structure or topology of coils or coil designs]

Square Coil

Rounder Coil

Next page is posting from Astronomy.com which says besides other things. “On Monday, I also plan on putting a USPTO Document Deposit on an idea that I thought was worthwhile. Swinging Foucault Pendulum as a magnet. Spins over a coil. The swinging magnet produces an electric current in the coil. Using Foucault's Pendulum to produce energy. Of course, Foucault is the one who belongs. I just borrowed his idea. I thought I should put in public domain even though I want to do a USPTO document deposit.”

This device can be used to generate a small current.

Some possible tools to keep the Foucault pendulum moving are

1. Hands or manual movement

2. Wind Power

3. Solar Power

4. Hydropower

5. Battery Power

6. Nuclear Power

7. Geothermal Power

8. Biogas Power

9. Garbage Burning Power

10. Astronomical Particle Power like the Falling of Astronomical particles

11. Other movement

12. Earth's movement

13. Boiling Water or other Fuels

14. Chemical Reactions

15. Volcanic heat

16. Animal Power like a horse moving or a fish moving around in a fish tank generating a pulling on the pendulum

As Earthquake Detection Device and Rotational Change Detection Device

This device can also be used to detect earthquakes. Please see descriptions in resources like Encyclopedia Brittanica page 901 from a recent edition. “The rotation of the plane of swing of Foucault's pendulum was the first laboratory demonstration of the Earth's spin on its axis.” “The rate of rotation of a Foucault pendulum at any given point is, in fact, numerically equal to the component of the Earth's rate of rotation perpendicular to the Earth's surface at that point.”

A recent DVD videotape “Wave That Shook The World” discussing the Dec. 24, 2004 tsunami from Nova discussed that the tsunami and earthquake shook the earth and changed the Earth's rate of spinning. If it shook the earth and spin rate, then the Foucault pendulum would be effected by some earthquakes. The earthquake effect would be small. Still, the device could be used to detect changes in the rate of rotation of the Earth at specific locations besides being used as an energy source. It is a Jet Propulsion Laboratory scientist, I think I recall, in that video who makes the argument that the earthquake shook the world.

If the spin of the earth changed radically, there would be a different amount of current generated by the Foucault pendulum. A constant current generation could be determined and then with earthquakes a change in current generation could be studied as well. Earthquakes happen daily, but significant earthquakes might mean that a larger current.

The pattern of the current would also show the change in rotation of the earth at a specific point. It is in theory possible that different parts of the earth could have changing rates of rotation at different times.

Other Planets, Moon, Comet, Asteroid and Other Solid Object Rotational Rate Detection Device

This device could be used on other planets, but would not have as much use on the equator. At the Equator, 0 degrees latitude, a Foucault pendulum does not rotate. (Encyclopedia Brittanica, Chicago p. 901) The device could then be used to detect a rotation rate on another planet. We could plant this device on any planet anywhere to get a planetary, moon, asteroid, comet, or other solid object rotation.

Not Experimentally Verified Yet

The amount of energy produced is unclear. I did not build a model myself thus far. I just requested that 1 or 2 institutions run tests of the device.

Non Planetary Uses on Astronomical Craft

This device would have similar uses on astronomical craft. Some of them spin or rotate at a certain rate. The Foucault pendulum rotation rate would reflect the rotation rate of the astronomical craft. I could detect rotation rate by placing a coil underneath and detecting changes in energy production. One use would be to show a slowing of rotation rate due to changes in frictional forces or reductions in power or to changes in position.

Thank you to the work of Jean Bernard Leon Foucault and the Pantheon in Paris for displaying his discovery.

The drawings will be sent separately as I am not good at doing PDF's of drawings.

1. A magnetized Foucault pendulum would cause a current in a coil. This could be used as a source of energy to provide power.

2. Device to study rate of oscillation change between a coil and a magnet on a Foucault pendulum. Magnet and Foucault pendulum interaction with coil gains understanding of electrical and magnetic interaction.

3. Device to use Astronomical Particle Power, Volcanic Power, Fish Power through the Falling of Astronomical particles, movement of a fish, heat from volcano tied to a pendulum to power a Foucault pendulum.

4. Device for Detection of Earthquakes through Changes in Energy Produced in a Coil With A Magnetized Foucault Pendulum

5. Changes in Asteroid, Moon, Planet, Astronomical Craft Rotational and Spin Changes through changes in energy produced in a coil around a Magnetized Foucault Pendulum
